(19) United States
(12) Patent Application Publication
(10) Pub. No.: US 2012/0105876 A1
(43) Pub. Date: May 3, 2012

(54) COLOR PLANE REGISTRATION ERROR CORRECTION

(76) Inventors: Eyal Peleg, Zoran (IL); Tsahi Rosenbaom, Rishon le zion (IL); Dani Sagi, Rishon le zion (IL); Eitan Kichli, Petach Tikva (IL)

(21) Appl. No.: 12/916,564

(22) Filed: Oct. 31, 2010

(51) Int. Cl. H04N 1/60

(52) U.S. Cl. 358/1.9

(57) ABSTRACT

A printing method and system include printing a first image on a first portion of a first page and determining a color plane registration (CPR) error using a second portion of the first page. A second image is modified based on the CPR error, and the second image is printed on a second page.

### BACKGROUND

Many color printing technologies, for example digital presses and high speed printers, require that pixels of different colors be properly aligned with each other. Color plane registration (CPR) error can cause visible print artifacts if the error is greater than some threshold level, for instance, 50 microns. Although printing systems such as printers, presses and digital presses are manufactured to minimize CPR error, it tends to vary over time and when the printed image or printing conditions change, such as when printing on different types of paper.

It is thus desirable to measure CPR error during the printing operation and adjust the printing process as necessary. Some CPR error measurement methods are manual. For example, one CPR error measurement method prints several lines with known offsets. An operator manually checks which lines are aligned with each other to determine the error.

To eliminate human intervention and associated inaccuracies, other methods to measure CPR errors are automated. For instance, marks are printed on a test page, and an imaging device, such as a scanner or camera, captures an image of the printed marks. The image is then analyzed to determine the CPR error. The distance between printed marks or the optical density of the printed marks can be measured to determine CPR error, for example. Once the CPR error is determined, the printing system can be adjusted to correct for the error.

However, after adjusting the printing system in response to the CPR error, mechanical factors, temperature change, changes in ink viscosity, etc. can change the geometry of the page and create additional CPR error. Page deformations are not necessarily constant with time, and there are some effects that may change it gradually. Such variations subsequent to printing of the test page, for example, can result in variations in the transfer of different ink colors to the paper causing the CPR error to change. This could render the previous adjustments ineffective in correcting the CPR error determined in conjunction with the printed test page, which in turn can reduce print quality.

### BRIEF DESCRIPTION OF THE DRAWINGS

FIG. 1 is a block diagram conceptually illustrating an example of a printing system.

FIG. 2 is a flow diagram illustrating an example of a printing method.

FIG. 3 conceptually illustrates an example of a printed page.

FIG. 4 conceptually illustrates an example of another printed page.

FIG. 5 is a flow diagram illustrating an example of a continuation of the printing method shown in FIG. 2.

FIGS. 6 and 7 are flow diagrams illustrating examples of further printing methods.

### DETAILED DESCRIPTION

In the following detailed description, reference is made to the accompanying drawings which form a part hereof, and in which is shown by way of illustration specific disclosed embodiments. In this regard, directional terminology, such as “top,” “bottom,” “front,” “back,” “leading,” “trailing,” etc., is used with reference to the orientation of the Figure(s) being described. Because disclosed components can be positioned in a number of different orientations, the directional terminology is used for purposes of illustration and is in no way limiting. It is to be understood that other embodiments may be utilized and structural or logical changes may be made without departing from the scope of the disclosure. The following detailed description, therefore, is not to be taken in a limiting sense.

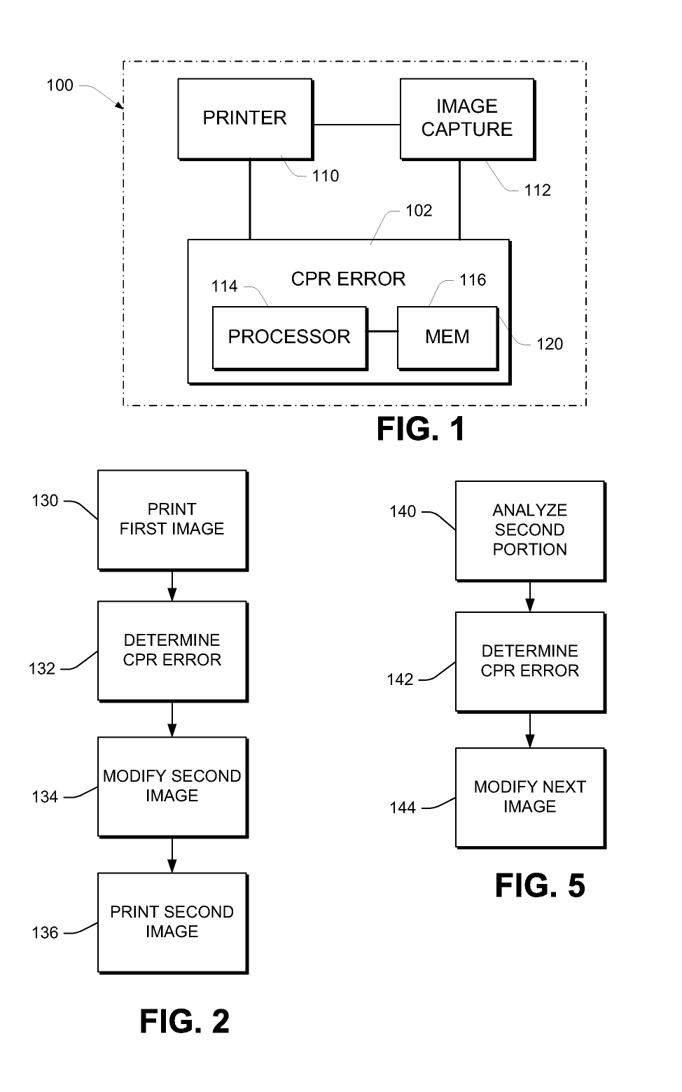

FIG. 1 conceptually illustrates an example of a printing system 100, including a printing device 110 such as a printer, press or digital press, an image capture device 112 such as a scanner and a color plane registration (CPR) error module 102. The CPR error module 102 includes a processor 114 and a memory device 116 accessible by the processor 114. The CPR error module is configured to implement a method for determining and addressing CPR error. The various functions, processes, methods, and operations performed or executed by the CPR error module 102 can be implemented as program instructions (also referred to as software or simply programs) that are executable by the processor 114, which could be any of various types of computer processors, controllers, central processing units, microprocessors, digital signal processors, state machines, programmable logic arrays, and the like. In some implementations, the printing system 100 may be networked (using wired or wireless networks) with other systems, and the components of the system 100 may be local to the printer 110 and image capture device 112 or coupled thereto via a network.

In various implementations, program instructions may be stored on the memory 116, which could be any non-transient computer-readable medium for use by or in connection with any computer-related system or method. A computer-readable medium can be an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type.

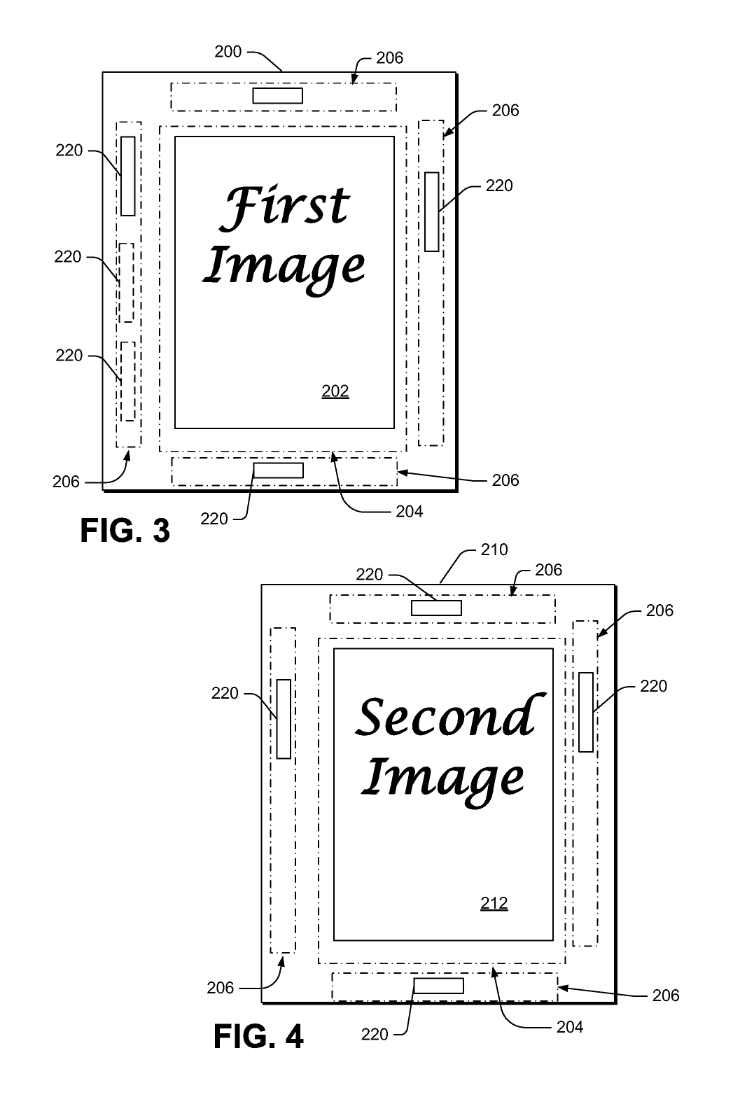

FIG. 2 is a flow diagram generally illustrating an example of an implementation of a printing method including a CPR error correction method, and FIG. 3 conceptually illustrates a first printed page 200 corresponding to the method of FIG. 2. In block 130, the printer 110 prints a first image 202 on a first portion 204 of the first page 200. In some implementations, the first image 202 is a “production” image—part of the particular print job the printing system 100 is generating. In block 132, a color plane registration (CPR) error is determined using a second portion 206 of the first page 200. In the example illustrated in FIG. 3, the first portion 204 of the page 200 is generally the center or “working” portion of the page, and the second portion 206 is outside the first portion 204, such as in the top, bottom or side margins of the page 200. A second image 212 is modified based on the determined CPR error to correct or compensate for the CPR error in block 134, and in block 136 the second image 212 is printed on a second page 210, as illustrated in FIG. 4.

In some implementations, determining the CPR error includes printing marks 220 in the second portion 206 of the first page in the various ink colors included in the printer 110. In the example first page 200 illustrated in FIG. 3, the marks 220 are printed in the side and top margins of the page 200, though in other implementations the marks 220 could be printed in one or the other of the top and bottom margins or in a single side margin, for example. Further, several sets of marks 220 could be printed in various areas of the second portion(s) 206 as indicated by the additional marks 220 shown in broken lines in the left margin area of the first page 200. In various embodiments, some or all of the second areas 206 of the page could have multiple sets of marks 220 printed thereon for determining CPR error. The image capture device 112, which could be implemented via a scanner or camera, captures an image of the marks 220, to which image processing is applied by the CPR error module 102 for determining the CPR error. For instance, in embodiments where the printer 110 includes four ink colors, cyan (C), magenta (M), yellow (Y) and black (K), four marks 220 for each of the respective four colors (CMYK) could be printed at predetermined locations in the second portion 206. The captured image of the marks 220 is then analyzed to determine the offset between the desired predetermined locations of the marks and the actual location of the printed marks. The second image 212 is modified or “distorted” based on these offsets to correct for the CPR error prior to printing the second image 212 on the second page 210.

In still further implementations, the edges of the page 200 are analyzed to determine the CPR error, in addition to or in place of printing the marks 220 in the second area 206 of the page 200. CPR errors are often due at least in part to paper movement between transfers of the various ink colors as an image is created. Such paper movements between successive impressions are estimated in some implementations based on paper edge movement between the impressions.

Thus, rather than printing a separate test or calibration page for determining CPR error, then printing all the pages of a print job, the CPR error is determined and corrected in line based on actual production pages in a print job. The process illustrated in FIGS. 2-4 can be repeated periodically at predetermined intervals, or even for each page so that the CPR error is continually or periodically checked and corrected, providing a closed-loop system. FIG. 5 illustrates a continuation of the method illustrated in FIG. 2 in accordance with some implementations. In bock 140, the second portion 206 of the second page 210 is analyzed. For example, the marks 220 can be printed in the second portion 206 of the second page 210 as illustrated in FIG. 4. The second portion 206 of the second page 210 is analyzed to determine the CPR error or adjust the CPR error previously determined as indicated in block 142, and the newly determined or adjusted CPR error can then be used to modify the subsequent image for the next page in block 144.

In some implementations, further factors are used to determine the CPR error and/or the modifications required to correct the CPR error in the printed images. For example, data related to the printer 110, the type of paper, etc. can be used for this purpose. Further, as illustrated in FIGS. 3 and 4, the first portion 204 of the page where the production image is produced typically is the center portion of the page. However, the second portion 206 of the page is used for CPR error determination. Thus, in some embodiments, a test or calibration page is periodically printed wherein calibration marks are printed in both the first portion 204 and second portion 206 of the page so that the CPR error determinations based on the first portion 204 can be compared to the CPR error determined based on the second portion 206 of the page, and the results can be correlated to determine the relationship of one to the other. This correlation can then be used in the image modification to correct the determined CPR error.

In blocks 132 and 142, the CPR error could be determined using any number of image processing methods. The distance between printed marks 220 or the optical density of the CPR correction printed marks 220 can be measured and analyzed to determine CPR error, for example. U.S. patent application Ser. No. 12/872,429, which is incorporated by reference, discloses another suitable CPR error measurement method in which the centers of gravity between patterns of printed marks are determined and analyzed. Yet another suitable CPR error measurement method is disclosed in U.S. Pat. No. 7,679,630, which is incorporated by reference, where a printed calibration pattern is analyzed to translate horizontal CPR error to an indication of CPR error in a process direction.

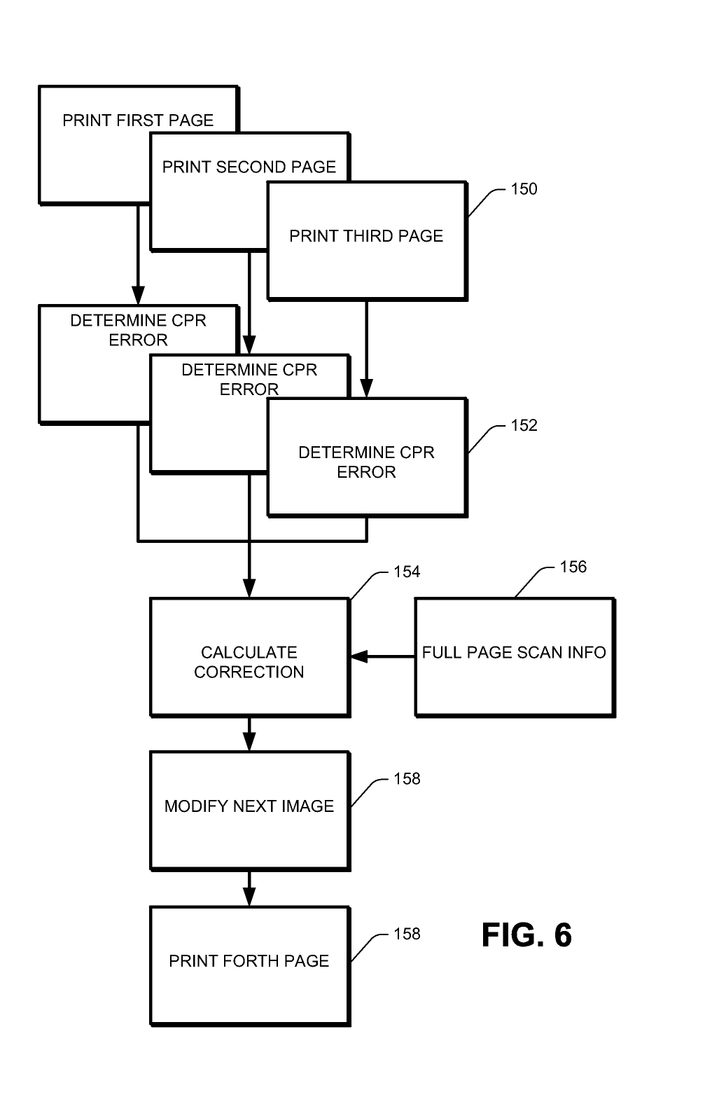

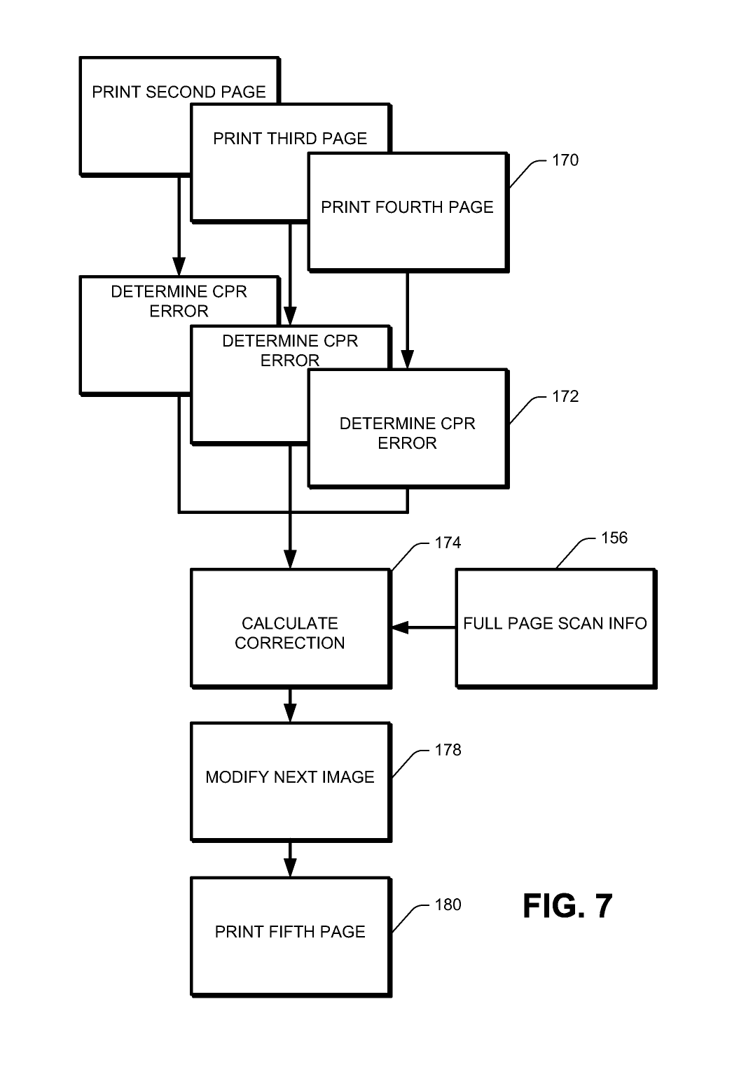

FIGS. 6 and 7 illustrate examples of further printing methods in which multiple printed pages are used for determining and correcting CPR error. In FIG. 6, CPR error is determined using three printed pages, for example. First, second and third pages are printed in blocks 150, and in blocks 152 the CPR error is determined for the respective printed pages. Based on the CPR for each of these three pages, a correction to the next image is determined in block 154. As noted above, in some implementations a test page is printed with CPR determination marks 220 printed in both the first and second portions of the page, so that determined CPR error based on the marks 220 in the second portion 206 can be compared with the CPR error determined based on the marks 220 in the first portion 204 of the page. Thus, the CPR error is determined based on a scan of the full page. This information can also be used in determining the adjustment to the next image as shown in block 156. In block 158 the forth page is printed with the modified next image.

FIG. 7 illustrates an example of a method in which the CPR error is determined based on a “rolling” multi-page set of images. Block 170 indicates the printing of the second, third and forth pages, and the respective CPR errors for the second, third and forth printed pages are determined in blocks 172. The CPR error correction based on the second, third and forth pages is determined in block 174. As noted in conjunction with FIG. 6, the information from the full page scan 156 can also be used in the CPR error correction determined in block 174. In block 178 the next image is modified based on this CPR error and the fifth page is printed in block 180. In other embodiments, the CPR error is based on two pages, or more than three pages, or on non-consecutive pages, etc.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A printing method, comprising:
printing a first image on a first portion of a first page;
determining a color plane registration (CPR) error using a second portion of the first page;
modifying a second image based on the CPR error;
printing the second image on a second page.

2. The method of claim 1, wherein determining the CPR error includes:
printing a plurality of marks in a respective plurality of colors in the second portion of the first page;
capturing an image of the plurality of marks;
analyzing the captured image of the plurality of marks.

3. The method of claim 1, wherein the second portion of the first page includes at least one of a side margin and a top margin of the first page.

4. The method of claim 1, wherein determining the CPR error includes analyzing an edge of the first page.

5. The method of claim 1, wherein determining the CPR error includes determining an offset distance between first and second colors, and wherein modifying the second image includes modifying the first and second colors in the second image based on the determined offset distance.

6. The method of claim 1, further comprising:
determining the CPR error based on the second portion of the first page and a second portion of the second page.

7. The method of claim 6, further comprising:
printing a plurality of marks in the respective plurality of colors in the second portion of the second page;
capturing an image of the plurality of marks;
analyzing the captured image of the plurality of marks to determine the CPR error.

8. The method of claim 1, further comprising:
determining the CPR error using a second portion of a predetermined number of pages preceding the first page.

9. The method of claim 1, further comprising:
printing a test page;
determining a CPR error based on first and second portions of the test page; and
modifying the second image based on the CPR error determined from the first and second portions of the test page.

10. A printing system, comprising
a printer configured to print a first image on a first portion of a first page;
a color plane registration (CPR) error module configured to analyze a second portion of the first page to determine a CPR error; and
modify a second image based on the CPR error.

11. The printing system of claim 10, wherein the printer is configured to print the modified second image on a first portion of a second page.

12. The printing system of claim 10, further comprising:
an image capture device;
wherein the printer is configured to print a plurality of marks in a respective plurality of colors in the second portion of the first page;
wherein the image capture device is configured to capture an image of the plurality of marks; and
wherein the CPR error module is configured to analyze the captured image of the plurality of marks.

13. The printing system of claim 10, wherein the second portion of the first page includes at least one of a side margin and a top margin of the first page.

14. The printing system of claim 10, wherein the CPR error module is configured to determine an offset distance between first and second colors, and wherein modifying the second image includes modifying the first and second colors in the second image based on the determined offset distance.

15. A non-transient storage medium including program instructions for implementing a printing method, comprising:
printing a first image on a first portion of a first page;
determining a color plane registration (CPR) error using a second portion of the first page;
modifying a second image based on the CPR error;
printing the second image on a second page.
